(19) United States
(12) Patent Application Publication
(10) Pub. No.: US 2012/0086626 A1
(43) Pub. Date: Apr. 12, 2012

(54) FEEDBACK STRUCTURE FOR AN ORGANIC LIGHT-EMITTING DIODE DISPLAY

(76) Inventors: Yu-Pin LIAO, Taichung City (TW); Ying-Ju Liu, Taichung City (TW); Chih-Wei Chiang, Taichung City (TW)

(21) Appl. No.: 12/900,231

(22) Filed: Oct. 7, 2010

(51) Int. Cl. G09G 3/30

(52) U.S. Cl. 345/76

(57) ABSTRACT

A feedback structure for an organic light-emitting diode display comprises an organic light-emitting diode panel, a driver chip and a signal transmission line group. The organic light-emitting diode panel includes a signal input terminal group and a signal feedback term connected to the ground. The driver chip includes a power input port connected to an external power source, a signal input port, and a feedback port connected to the ground. The signal transmission line group is electrically connected between the signal input terminal group and the signal output port. By such arrangements, it can ensure a stable segment control signal or avoid damage to the driver chip.

### BACKGROUND OF THE INVENTION

1. Field of the Invention

The present invention relates to an organic light-emitting diode display, and more particularly to a feedback structure for an organic light-emitting diode display.

2. Description of the Prior Art

Organic light-emitting diode (hereinafter called OLED) displays are divided into two types according to the drive modes: one is passive matrix type and the other is active matrix type. The active matrix OLED displays employ capacitor to store signal, so that the pixel will still maintain its original lightness after being scanned by the scanning beam. In the passive matrix OLED displays, only the pixels which are scanned by the scanning beam can be turned on. However, the image displaying light sources of the OLED panel for both the passive matrix OLED displays and the active matrix OLED displays are driven by a driver chip.

Referring to FIG. 1 which is a circuit diagram illustrating a structural relationship between a conventional OLED panel 11 and a driver chip 12, the OLED panel 11 comprises a signal input terminal group 111 and a signal feedback terminal group 112. The driver chip 12 includes a power input port 121 connected to an external power source 13, a signal output port 122 and an earthing feedback port 123. The signal output port 122 is electrically connected to the signal input terminal group 111 of the OLED panel 11 through a signal transmission line group 14. The feedback port 123 is electrically connected to the signal feedback terminal group 112 of the OLED panel 11 through a feedback line group 15. Hence, the OLED panel 11 will be turned on by the driver chip 12 through the cooperation of a segment control signal form the signal output port 122 and a common control signal from the feedback port 123. However, the above OLED display suffers from the following drawbacks in practice use:

Since the feedback port 123 of the driver chip 12 is electrically connected to the signal feedback terminal group 112 through the feedback line group 15, when the OLED panel 11 is turned on, the respective terminals of the signal feedback terminal group 112 of the OLED panel will all output an electric current into the driver chip 12. However, if overlarge current flows into the driver chip 12, it will lead to over-heat inside the driver chip 12, which might cause the segment control signal unstable, or even burn down the driver chip 12. Specially, if the feedback port 123 of the driver chip 12 has over-many terminals (in other words, the signal feedback group 111 of the OLED panel 11 has over-many terminals), the above drawback is more likely to occur in the above OLED panel 11.

The present invention has arisen to mitigate and/or obviate the afore-described disadvantages.

### SUMMARY OF THE INVENTION

The primary objective of the present invention is to provide a feedback structure for an organic light-emitting diode display which can avoid damage to the driver chip.

The secondary objective of the present invention is to provide a feedback structure for an organic light-emitting diode display which can prevent the driver chip from outputting an unstable segment control signal.

Hence, to achieve the above objectives, a feedback structure for an organic light-emitting diode display in accordance with the present invention comprises an organic light-emitting diode panel, a driver chip and a signal transmission line group. The organic light-emitting diode panel includes a signal input terminal group and a signal feedback term connected to the ground. The driver chip includes a power input port connected to an external power source, a signal input port, and a feedback port connected to the ground. The signal transmission line group is electrically connected between the signal input terminal group and the signal output port.

Preferably, the signal feedback terminal group of the organic light-emitting diode panel is electrically connected to a first end of a feedback circuit group, and a second end of the feedback circuit group is connected to the ground.

Preferably, the signal transmission line group includes plural signal transmission circuits, the signal input terminal group includes plural terminals, the signal output port includes the same number of terminals as the signal input terminal group, the respective signal transmission circuits are electrically connected between the respective terminals of the signal input terminal group and the respective terminals of the signal output port.

### BRIEF DESCRIPTION OF THE DRAWINGS

FIG. 1 is a circuit diagram illustrates a structural relationship between a conventional OLED panel and a driver chip; and

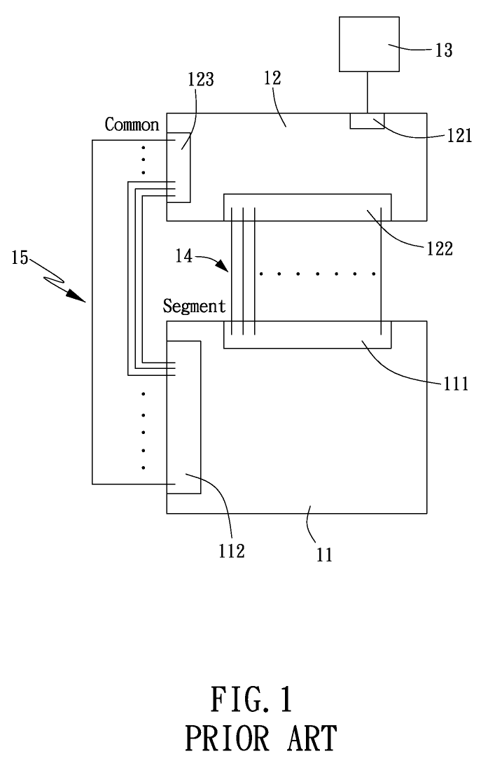

FIG. 2 is a circuit diagram of a feedback structure for an organic light-emitting diode display in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

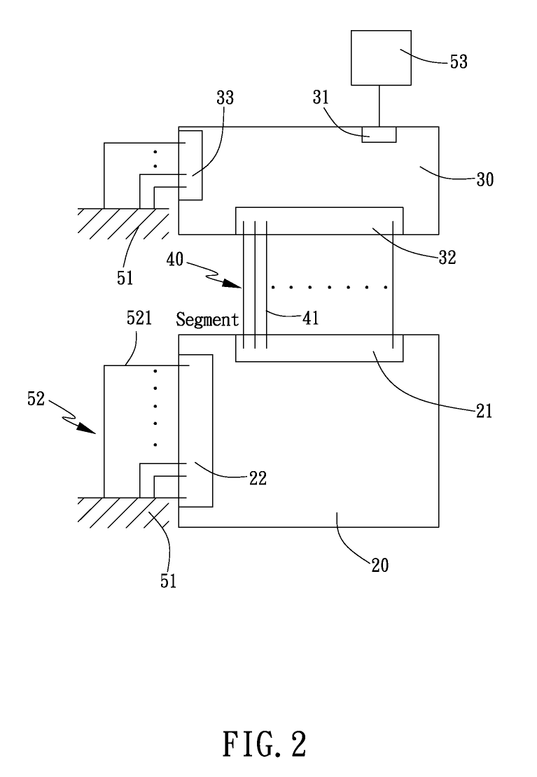

Referring to FIG. 2 which is a circuit diagram of a feedback structure for an organic light-emitting diode display in accordance with a preferred embodiment of the present invention, the organic light-emitting diode (hereinafter called OLED) display can be a passive matrix OLED display or an active matrix OLED display. The OLED display comprises an OLED panel 20, a driver chip 30, and a signal transmission line group 40.

The OLED panel 20 includes a signal input terminal group 21 and a signal feedback terminal group 22 connected to the ground 51. The signal input terminal group 21 includes plural terminals, and the signal feedback terminal group 22 includes plural terminals connected to the ground 51. In the present embodiment, the signal feedback terminal group 22 is connected to the ground 51 in such a manner that the signal feedback terminal group 22 is electrically connected to a first end of a feedback circuit group 52, and a second end of the feedback circuit group 52 is connected to the ground 51. In addition, the feedback circuit group 52 includes plural feedback circuits 521 the number of which is the same as that of the terminals of the signal feedback terminal group 22.

The driver chip 30 includes a power input port 31 connected to an external power source 53, a signal output port 32, and a feedback port 33 connected to the ground 51. The signal output port 32 includes the same number of terminals as the signal input terminal group 21.

The signal transmission line group 40 is electrically connected between the signal input terminal group 21 and the signal output port 32. The signal transmission line group 40 includes plural signal transmission circuits 41 which are electrically connected between the respective terminals of the signal input terminal group 51 and the respective terminals of the signal output port 32.

The aforementioned is the summary of the positional and structural relationship of the respective components of the preferred embodiment in accordance with the present invention.

Hence, since the signal feedback terminal group 22 of the OLED panel 20 is directly connected to the group 51 or connected to the ground 51 through the feedback circuit group 52, when the driver chip 30 sends out a segment control signal, the OLED panel 20 will be turned on. The electric current outputted from the respective terminals of the signal feedback group 22 of the OLED panel 20 will directly flow to the ground 51 but not flow inside the driver chip 30, avoiding damage to the driver chip 30 or occurrence of unstable segment control signal.

While we have shown and described various embodiments in accordance with the present invention, it is clear to those skilled in the art that further embodiments may be made without departing from the scope of the present invention.

What is claimed is:

1. A feedback structure for an organic light-emitting diode display comprising:
an organic light-emitting diode panel including a signal input terminal group and a signal feedback terminal group connected to the ground;
a driver chip including a power input port connected to an external power source, a signal output port, and a feedback port connected to the ground; and
a signal transmission line group electrically connected between the signal input terminal group and the signal output port.

2. The feedback structure for an organic light-emitting diode display as claimed in claim 1, wherein the signal feedback terminal group of the organic light-emitting diode panel is electrically connected to a first end of a feedback circuit group, and a second end of the feedback circuit group is connected to the ground.

3. The feedback structure for an organic light-emitting diode display as claimed in claim 1, wherein the signal transmission line group includes plural signal transmission circuits, the signal input terminal group includes plural terminals, the signal output port includes the same number of terminals as the signal input terminal group, the respective signal transmission circuits are electrically connected between the respective terminals of the signal input terminal group and the respective terminals of the signal output port.
